(19) United States
(12) Patent Application Publication
(10) Pub. No.: US 2005/0288197 A1
(43) Pub. Date: Dec. 29, 2005

(54) Silicone polymer topical eye compositions and methods of use

(75) Inventor: Gerald Horn, Deerfield, IL (US)

Correspondence Address: KIRKPATRICK & LOCKHART NICHOLSON GRAHAM LLP;(FORMERLY KIRKPATRICK & LOCKHART LLP), 75 STATE STREET, BOSTON, MA, 02109-1808, US

(73) Assignee: Ocularis Pharma, Inc., North Riverside, IL (US)

(21) Appl. No.: 11/148,052

(22) Filed: Jun. 8, 2005

Related U.S. Application Data
(60) Provisional application No. 60/577,837, filed on Jun. 8, 2004.
(60) Provisional application No. 60/610,788, filed on Sep. 16, 2004.

(51) Int. Cl. C11D 3/00

(52) U.S. Cl. 510/112

(57) ABSTRACT

The present invention is an eye preparation comprising a hydrophobic composition adapted for use on a patient's eye and having a viscosity of 1 to 15,000 centistokes. The composition includes a silicone polymer, fluorinated silicone polymer, fluorocarbon polymer, fluorinated alcohol, or perfluorinated polyether composition, singly or blended, adapted to coat at least a portion of a patient's eye. Silicone polymers for use in the invention include dimethicone, cyclomethicone, and silicone gums.

### RELATED APPLICATIONS

This application claims priority to and the benefit of U.S. provisional patent application No. 60/577,837, filed Jun. 8, 2004, and U.S. provisional patent application No. 60/610,788, filed Sep. 16, 2004, the entire contents of which are incorporated by reference herein in their entirety.

### TECHNICAL FIELD OF THE INVENTION

The present invention relates generally to eye drops and gel compositions and more specifically to silicone, nonaqueous silicone, perfluorocarbon, perfluorosilicone, fluorinated alcohol and perfluorinated polyether polymer eye drops, gels and contact lens conditioning agents and methods of use.

### BACKGROUND OF THE INVENTION

It is well known that contact lens wearers experience a variety of problems and complications from contact lens wear, including dry eye, allergic reactions, inflammatory responses, conjunctivitis, limbal neovascularization, pannus (more extensive neovascularization), epithelial abrasion, superficial punctate keratitis, keratitis, corneal ulceration (keratitis with loss of stromal tissue), and tight contact lens syndrome. Nearly twenty-five percent of contact lens wearers stop wearing their lenses due to these difficulties. Some studies show that about fifty percent of contact lens wearers experience bothersome dry eye at some point during the day or evening.

Silicone hydrogels also cause pervaporation, where the high water permeability of the silicone hydrogel lens leads to water vapor permeating through the lens and being lost to the air, with resultant drying of the corneal epithelium. Soft contact lenses sticking to the epithelium is a problem related to water loss through these lenses, but is particularly troublesome with silicone hydrogel lenses. The hydrophobic surface of the silicone hydrogel lens sticks to epithelium preferentially. Some soft contact lenses have hydrophilic or bipolar surfaces. These surfaces attract protein and mucin deposits. Hydrophobic surfaces, like those of silicone hydrogels, attract lipid deposits.

Cormnercially available contact lens solutions offer almost no relief for these problems. Being aqueous based, immiscible in an aqueous solution by design, their benefits are limited to moments of hydration and lens surface coating. In clinical use, it is not moments but hours of benefit that are needed. A recent study of the effect of artificial tears on visual performance in normal subjects wearing contact lenses further documents the problems with leading contact lens solutions for this purpose. In that study, three conditions were investigated: (1) without artificial tears added, (2) with Clerz2 (Ciba Vision) instilled, and (3) with Sensitive Eyes (Bausch & Lomb) applied. The results of this study demonstrated that high spatial frequency contrast sensitivity was found to be reduced after tear film break-up and was not enhanced by either tear solution. Accordingly, conventional aqueous contact lens solutions provide poor pre-lens tear film stability.

Soft contact lenses, such as hydrogels, retain the necessary oxygen permeability by being water filled. The water in such lenses includes bonded and nonbonded water. Nonbonded water stays in an equilibrium with aqueous from the ocular epithelium, from the tear film cushion underneath the lens, from the lens itself, from water released at the anterior lens surface, and from the atmosphere.

When a lens is first inserted after being soaked overnight in soaking solution, the lens is filled as designed with water and has its ideal shape. It is well known that shape retention is necessary for excellent optics, which is why gas permeable and hard contact lenses are known to provide the best acuity when all other variables are similar. When a soft lens is worn, the hydration of any soft contact lens changes quickly. The changes in lens optics with soft contact lens hydration loss are well documented. These changes include change in the radius of curvature of the lens (usually steepening), change in the dioptric power, change in the lens' thickness, and change in the lens' refractive index. All of these changes alter the optics in an undesirable way.

Many factors serve to cause irritation and reduce visual quality. These factors include the difficulty of maintaining sufficient tears to equal water loss, reduced oxygen permeability as water is lost to the lens, and deposits that accumulate on the lens surface. Soft contact lens deposits include protein, mucin, and lipid deposits. All of these deposits decrease comfort, increase allergic reactions, and create a disturbance in the anterior and posterior tear film stability resulting in increased water loss within the lens to evaporation and reduced night vision due to glare and halo from the distortions of the contact lens shape and diffraction of light by the deposits.

When the tear film fails to perform its functions of lubrication, oxygenation, and removal of debris, particularly with contact lens wear, symptoms of foreign body sensation (grittiness, scratchiness, sandiness), fatigue, and dryness result. A patient may experience severe pain, especially in the presence of filamentary keratopathy. Loss of the smooth refractive surface of the tear film causes blurred vision, which can vary from blink to blink, accounting for a variable manifest refraction and for complaints of variable vision throughout the day. Surface drying may produce reflex tearing and the misleading complaint of excess tears. Typically, symptoms are worse late in the day, with prolonged use of the eyes (as when the patient reads or watches television), and in conditions of heat, wind, and low humidity (as on the beach or ski slopes). Symptoms that are worse in the morning suggest an associated chronic blepharitis, recurrent corneal epithelial erosion, or exposure keratopathy. Further, symptoms include superficial punctate erosions, corneal filaments, coarse mucus plaques, and epithelial defects.

As hereinabove noted, most of these symptoms result from the unstable tear film and contact lens changes from water loss. The resulting abnormal ocular surface from epithelial changes due to epithelial water loss and touch to the lens surface further diminish the ability of the ocular surface to respond to environmental challenges. Dry eye, if left untreated, can cause progressive pathological changes in the conjunctival and corneal epithelium.

The tear film in a normal eye consists of a thin (about 6-45 um in thickness) film composed of a mucous layer lying over the corneal epithelium and an aqueous layer covering the mucous layer and epithelium, which is in turn covered by an extremely thin (0.01-0.22 um) layer of lipid molecules.

The presence of a continuous tear film is important for the well-being of the corneal and conjunctival epithelium and provides the cornea with an optically high quality surface. In addition, the aqueous part of the tear film acts as a lubricant to the eyelids during blinking of the lids. Furthermore, certain enzymes contained in the tear fluid, for example, immunoglobulin A, lysozyme and beta lysin, are known to have bacteriostatic properties. Contact lens wear negatively affects this physiology.

Taking into account evaporation, the continuous production and drainage of aqueous tear is important to maintaining the corneal and conjunctival epithelium in a moist state, in providing nutrients for epithelian respiration, in supplying bacteriostatic agents and in cleaning the ocular surface by the flushing action of tear movement.

A key deficiency in dry eye syndromes, or pseudo dry eye syndromes induced by contact lens wear, is reduced protection from evaporation by a reduced or otherwise deficient oil layer. Likewise, improving the protection provided by a layer that reduces aqueous evaporation leads to effectively more tear volume and a prolonged tear break up time, resulting in a more effective and physiologic lubrication of the corneal surface. Clearly, such a lubricant must offer excellent properties of oxygen diffusion as well as reduced aqueous evaporation for greatest efficacy.

Normally, aqueous-deficient dry eye states, such as, keratoconjunctivitis sicca (KCS), are treated by supplementation of the tears with artificial tear substitutes. However, relief is limited by the retention time of the administered artificial tear solution in the eye. Typically, the effect of an artificial tear solution administered to the eye dissipates within about five to fifteen minutes. The effect of such products, while soothing initially, does not last long enough. The patient is inconvenienced by the necessity of repeated administration of the artificial tear solution in the eye as needed to supplement the normal tears.

Presently, artificial tear preparations, lens rewetting solutions and ophthalmic lubricants and ointments utilizing active components to provide a thin protective film to reduce evaporation while allowing effective oxygen diffusion are nonexistent. Such available artificial tear solutions commonly include carboxymethyl, methyl or ethyl cellulose or polyvinyl alcohol as the principal active ingredient. Lubricants and ointments tend more toward replacement of oil in the lipid layer of the tear film and commonly include petrolatum, lanolin and/or mineral oil.

As with artificial tears, contact lens rewetting products vary in composition. The solutions are typically aqueous, buffered solutions which frequently contain carboxymethyl, methyl or ethyl cellulose, polyvinyl alcohol and/or glycerin. There is a growing understanding of the factors involved in the inflammation of the ocular environment and in particular in contact lens wear, where a vast array of contact lens materials are available and it is known that foreign materials can aggravate or modulate the normal host immune response. Spoilation by proteins has the potential to stimulate, mediate or produce excessive immunological reactions. Vitronectin, for example, is an important inflammatory marker which can be detected on the lens surface by means of an on-lens, cell-based assay. The advent of disposable and frequent replacement lenses has not overcome the problems associated with lens-tear interactions. Indeed, the widespread use of high water content, ionic lenses has made the problem more acute.

Tight Contact Lens Syndrome occurs when a contact lens becomes poorly fitting. Because of a variety of factors, including tear film deficiencies and changes in corneal curvature with contact lens wear, a tight contact lens syndrome may occur even in patients with initially well-fitting contacts. The patient usually complains that the lens feels fine until after a few hours of wear, at which point it becomes uncomfortable. The eye may also become red. The symptoms usually resolve within a few hours after discontinuance of contact lens wear. Tight contact lens syndrome can often be diagnosed by the ophthalmologist with the pertinent history and examination, the latter of which shows a contact lens that scarcely moves on the cornea with blinking. As the aqueous layer between the corneal epithelium and the contact lens becomes reduced, direct contact between the posterior contact lens surface and the anterior epithelium can occur. This results in punctate keratitis, inflammation and irregularity of the epithelial layer that is painful and increases infection risk. Corneal abrasion may result as well. Protein deposition on the contact lens surface results that creates added inflammatory reaction. Such lenses become difficult to remove and vision, particularly at night, becomes dangerously reduced with glare, halo effects, reduced contrast sensitivity, reduced acuity, including that induced by poor centration as the lens tightens.

Currently, no artificial tear solution or contact lens rewetting solution offers protection from the deleterious effects of uv-a and uv-b radiation. Though many glasses provide such protection, this is not uniform; is not afforded as completely by the unprotected eye; and is not afforded such protection by most contact lens materials.

### SUMMARY OF THE INVENTION

In one aspect, the present invention is a hydrophobic composition adapted for application to a contact lens and for treatment of the eye of the contact lens wearer. The eye preparation, when applied, produces a long lasting microfilm that disperses easily and has a low vapor pressure. The eye preparation is also hydrophobic, retarding evaporation of free water from the contact lens. The eye preparation is also available in a range of viscosities and oleophobicities by blending compositions of various viscosities and levels of fluorination to achieve the desired preparation characteristics. Increased oleophibicity of the composition, as typically occurs with increasing the fluorine concentration, improves the composition's resistance to being easily solubilized and washed away by the oil layer of tear film, as does increasing the viscosity of these naturally adherent polymers.

According to one embodiment, the eye preparation is a composition, containing either a single species or a blend of multiple species, selected from the following classes of compounds: silicone polymers, fluorinated silicone polymers, perfluorocarbons, fluorinated alcohols, and perfluorinated polyethers.

The eye preparation can be in the form of a liquid, a gel, or an emulsion and has a viscosity in the range of 1 to 15,000 centistokes, with a preferred contact lens conditioning agent embodiment having a viscosity of about 300 to 10,000 centistokes, preferably 8,000 centistokes. Higher viscosity varieties of polymers or emulsifiers may be added to the eye preparation to attain the desired viscosity of the final preparation.

In one embodiment, the eye preparation is in the form of a topical agent for application to the surface of an eye to treat symptoms associated with dry eye and dry eye syndrome. According to one exemplary embodiment, the topical agent composition can be applied directly to the surface of the eye. According to an alternative embodiment, the topical agent composition can be applied directly to the surface of the eye with a subsequent sequential application of an aqueous agent. According to another embodiment, the topical agent composition can be applied directly to the surface of the eye as an emulsion of the composition and the aqueous agent.

In another embodiment, the eye preparation is in the form of a contact lens conditioning agent for application to the anterior surface of the contact lens, the posterior surface of the contact lens, or both surfaces of the contact lens. The contact lens may be treated before insertion in the wearer's eye, or may be applied during wear, as needed. The contact lens conditioning agent may also be used in the packaging solution for new contact lens and in the storage solution for reusable lenses.

The eye preparation, formulated for use as a contact lens conditioning agent, retards surface deposits on the surface of the contact lens, thereby improving contact lens comfort and vision. The preparation retards aqueous deposition due to its hydrophobicity; mucous deposition due to its polar component; and oil deposition either by solubilizing until the oil is removed or retarding oil deposition by its oleophobicity. The preparation also acts as a cushion between the contact lens and the corneal and ocular epithelia, reducing the risk and incidence of abrasion and keratitis. The eye composition reduces friction and improves the glide of the lens, further improving lens comfort and reducing epithelial friction and the risk of tight contact lens syndrome. The preparation also seals the contact lens, maintaining adequate levels of free water within the contact lens. Adequate levels of free water within the contact lens maintain the surface curve, refractive index, and visual acuity of the contact lens. The eye preparation also improves the removability of the contact lens, allowing a wearer to remove the lens comfortably after long hours of wear, including after sleeping in the lens. Finally, the eye preparation maintains the oxygen permeability of the contact lens, increasing the amount of oxygen able to pass through to the corneal and ocular epithelia during contact lens wear.

According to one embodiment of the invention, the eye preparation is adapted to treat a defect of an ocular or corneal epithelia. According to an alternative embodiment, the eye preparation further includes a therapeutic agent, such as a lipophilic pharmaceutical agent, including cyclosporin. The therapeutic agent can be in a slow release formulation.

According to one embodiment, the composition is a silicone polymer. Preferred silicone polymers include dimethicone, cyclomethicone, silicone gums, and blends thereof. The silicones can also be fluorinated to improve the oleophobicity of the composition. Preferred fluorinated silicones include perfluorosilicone, specificially perfluorononyl dimethicone.

According to another embodiment, the composition is a perfluorocarbon polymer. Preferred perfluorocarbon polymers include perfluoro-n-octane and perfluoroalkane polymers.

In another embodiment, the composition is a fluorinated alcohol. Preferred fluorinated alcohols include dioctyldodecylfluoroheptyl citrate.

According to another embodiment, the composition is a perfluorinated polyether. Preferred perfluorinated polyethers include Fomblin Z and Fomblin Z-DOL.

In another embodiment, the composition is a blend of at least two classes of compounds selected from the group consisting of silicone polymers, fluorinated silicone polymers, perfluorocarbon polymers, fluorinated alcohols, and perfluorinated polyethers. Alternatively, the composition is a blend of at least two polymers within the same class of compound. Furthermore, according to yet another alternative, the composition is a single polymer in a blend of at least two different viscosities.

In another aspect, the invention is a method for delivering a hydrophobic composition to a contact lens or an eye. The method includes the steps of providing a hydrophobic composition and introducing the hydrophobic composition to the surface of the contact lens or the eye. According to one embodiment, the composition is introduced to the lens or the eye in an amount sufficient to deposit a microfilm of the composition on the surface of the eye or the lens. For example, the composition may be introduced to the lens by applying a single drop from an applicator and rubbing the surface of the lens, for example, between two fingers, to achieve distribution of the composition as a microfilm on the surface of the lens. The eye preparation can be supplied in an applicator for a single dose or multiple doses of the desired composition.

### DETAILED DESCRIPTION OF THE INVENTION

The ideal contact lens conditioning gel, artificial tear, or vehicle for delivery of drugs would have an extended half-life. Conventional contact lens solutions and tears, for example, have half-lives of only minutes. Similarly, aqueous-based artificial tears have half-lives of only minutes. Even nonaqueous formulations rarely last more than a few hours.

There is great potential clinical benefit for an eye preparation that, when applied, produces a long lasting microfilm that disperses easily, has a low vapor pressure so as to be longer lasting, which is hydrophobic to retard evaporation, and to some extent somewhat viscous, oleophobic, or both, to resist being easily solubilized and washed away by the oil layer or tear film of the eye. The composition should be clear in color to allow sight through the composition when applied either directly to the eye or first applied to a contact lens inserted in the eye. There is a further advantage to such compounds which have oxygen permeability as well.

Formulations for the purpose of the present invention, which have the desired characteristics, have been created in several embodiments, from several classes of compounds, including silicone formulations, fluorinated silicone formulations, fluorinated alcohols, perfluorocarbons, and perfluorinated polyethers, including fomblin z and fomblin z-dol lubricants.

Spectroscopic analysis of contact lens surfaces has demonstrated several impurities, such as silicon, on all contact lens surfaces. These impurities may facilitate Van der Walls type attraction to a variety of gels and or liquids that create an adherent film with desirable properties and thereby optimize contact lens performance. Such desirable properties include maintaining oxygen permeability, sealing the lens surfaces, and inhibiting lens deposits.

According to one embodiment, the present invention relates to an aqueous and/or nonaqueous silicone polymer composition eye preparation for conditioning the surface of a subject's eye or contact lens. The silicone composition is applied as a thin adherent film on the surface of a subject's eye or on the anterior or posterior or both contact lens surface(s) prior to insertion in a subject's eye to condition the contact lens and relieve symptoms associated with prolonged contact lens wear. The silicone composition is applied directly to the eye of a subject to relieve symptoms associated with dry eye conditions. According to an alternative embodiment, the eye composition is applied to all surfaces of a contact lens. For example, a microfilm results from applying the preparation to the lens surface(s), rubbing the lens edges together for a few seconds, and then rinsing with an aqueous solution and rubbing a second time. The silicone composition is a highly oxygen permeable, hydrophobic adherent film.

According to another embodiment, the present invention relates to a volatile and/or nonvolatile perfluorocarbon polymer composition eye preparation for conditioning the surface of a subject's eye or contact lens. The perfluorocarbon composition is applied as a thin adherent film on the surface of a subject's eye or on the anterior or posterior or both contact lens surface(s) prior to insertion in a subject's eye to condition the contact lens and relieve symptoms associated with prolonged contact lens wear. The perfluorocarbon composition is applied directly to the eye of a subject to relieve symptoms associated with dry eye conditions. The perfluorocarbon composition is a highly oxygen permeable, hydrophobic adherent film and provides similar benefits and mechanisms of action as silicon polymers.

According to another embodiment, the polymer composition is comprised of a fluorinated silicone, for example, a perfluorosilicone, a perfluorocarbon, or a perfluoroalkane. Fluorinating silicones and other polymers changes certain properties of the composition, for example, changing the viscosity, spreadability, and/or oleophobicity of the composition. Fluorinated polymers, for example, perfluorocarbons, perfluorosilicones, such as perfluorononyl dimethicone, and perfluoroalkanes, are oleophobic or insoluble in oil. Such polymers are not diluted or degraded by natural or foreign oils present in the ocular tear film or region, and are therefore able to retain their therapeutic effect within the eye for a longer period of time.

The polymer composition is in the form of a fluid, a gel, or an emulsion having a viscosity of 1 to 15,000 centistokes. A preferred polymer composition for application as a contact lens conditioning agent has a viscosity of about 300 to about 15,000 centistokes, preferably about 8,000 centistokes. A preferred polymer composition for topical application as a dry eye treatment has a viscosity of about 1 to about 8,000 centistokes, preferably about 200 to 400 centistokes. An emollient, for example but not limited to, docosyl docosanoate, is added to the polymer composition to increase the viscosity of the composition forming a gel or an emulsion. A silicone gum is added to the polymer composition to increase the viscosity of the composition.

According to one embodiment, the polymer composition comprises one of the following polymers in a substantially pure form: a silicone polymer, a nonaqueous silicone polymer, a perfluorocarbon polymer, a perfluorosilicone polymer, and a perfluoroalkane polymer. According to another embodiment, the polymer composition is a blend of at least two classes of polymers. Alternatively, the polymer composition is a blend of at least two polymers from the same class. Alternatively, the polymer composition is a single polymer blended from at least two viscosities of the polymer.

According to one embodiment, the polymer composition thin film is delivered directly to the ocular surface, for example, to treat a dry eye condition. One illustrative embodiment combines an aqueous solution with a hydrophobic oxygen permeable polymer composition. A further embodiment results from combining a hypertonic aqueous solution, such as a 0.1% to 10% saline solution, preferably a 0.5% to 2.5% saline solution, with the hydrophobic polymer, such as in an emulsion.

According to another embodiment, the polymer composition thin film is delivered to an anterior contact lens surface, a posterior contact lens surface, or both the anterior and posterior surfaces of a contact lens. The polymer is applied as a thin film to retard evaporation of the aqueous layer while still providing excellent oxygen diffusion to ocular tissues. According to another embodiment, the polymer composition further forms an aqueous solution used in packaging, storing, shipping, or distributing a contact lens, for example, a daily wear disposable contact lens. Alternatively, the polymer composition is used, either alone or in combination with other aqueous agents, as an overnight storage solution for daily wear contact lenses.

When the polymer composition thin film is applied to the contact lens, a dramatic improvement in contact lens function, comfort, and vision results. It is contemplated that the polymer composition thin film can be applied in its pure form, as an emulsion with an isotonic aqueous solution, or with immediate sequential application of aqueous solution. The adherent polymer composition reduces lens evaporation and the aqueous solution allows easier elimination of excess polymer. The aqueous solution also assists in providing an increase in the underlying aqueous volume beneath the contact lens, or beneath the polymer composition fluid layer in dry eye subjects. The polymer composition does not easily evaporate, which prolongs retention of this layer, along with the high oxygen diffusion properties of the preferred polymer composition.

The polymers have a high comfort level and low irritation potential suitable for delivery of medications to sensitive areas such as ocular tissues. Such polymers are well known for their excellent oxygen diffusion capabilities. For example, laboratory mice have been able to survive breathing an enriched silicone oil mixture. Because the surface of all soft contact lenses contain silicone either as an impurity or as part of the manufactured material, the polymer composition thin film binds well to the anterior contact lens surface, providing virtually immediate reduced evaporation with excellent oxygen diffusion.

The use of preinsertion polymer compositions on both sides of a hydrated lens allows for long hours of conditioning benefit that are supplemented by the less viscous topical application of similar polymer compositions to achieve hours of daily conditioning. According to one embodiment, the preinsertion high viscosity gel compositions last, for example, about 10 to 12 hours. According to another embodiment, the topical fluid reconditioning compositions last, for example, about 2 to 4 hours and can be repeated as needed.

The polymer compositions seal the ocular epithelium, preventing evaporative water loss from the ocular tissue and lubricating the mechanical motion of the eyelid. Unmodified polymers stay on or near the surface of the conjunctiva and corneal epithelium and are excellent lubricants. Not only are the molecules too big to physically enter past the upper living cells—they associate with the upper layer of drying epithelium—but they also cannot penetrate cell membranes due to their large size. The molecules lubricate the surface of the epithelium, relieving the mechanical distress of repeated eyelid motion over the dried epithelium. The molecules also dislike both the water and proteins inside cells, solubilizing lipid deposits and reducing their accumulation on the contact lens surface over time of use.

Multiple classes of compounds have been found to achieve the desired properties for conditioning the contact lens surfaces, either prior to insertion of the contact lens in the eye or as a topical application with or without contact lens wear. The first class of compounds is nonaqueous silicone polymers, including cyclomethicone, dimethicone, and silicone gums. According to one illustrative embodiment of the invention, a nonaqueous silicone polymer composition contains, for example, dimethicone dissolved in cyclomethicone. This composition is a blend of a high viscosity dimethicone gum and a low viscosity cyclomethicone liquid, resulting in a composition with a viscosity of preferably about 4,000 to 8,000 centistokes. A lower viscosity blend, with a higher relative concentration of cyclomethicone, is rapidly spread and even a small drop will coat the anterior contact lens surface during wear. Application of the lower viscosity composition provides immediate improvement in optics, followed by a continuous, gradual improvement that results as tears continue to reach the undersurface of the contact lens with an anterior surface waterproof seal, and rehydrate the lens.

Cyclomethicones are unmodified silicones. They evaporate quickly after application, helping to carry oils into the top layer of epidermis. From there, they may be absorbed by the epithelium. Cyclomethicones perform a similar function in hair care products by helping nutrients enter the epithelial keratin protein.

Dimethicones are also unmodified silicones. They form a barrier layer on the epithelium which must be renewed as the epithelium sloughs off. Dimethicones have been found to coat the surface of the epithelium and lubricate it, providing a function similar to mucin within tear film as well as providing an overlying floating protective layer.

Silicones form a protective layer which helps prevent transepithelial water loss, a very useful characteristic for dry eye patients as well as for prolonged comfortable and more functional contact lens wear. According to one embodiment, silicone gums add further protective coating. Silicones, including silicone gums, act to help seal moisture into the corneal epithelial keratin matrix.

According to one embodiment, a range of fluid properties of the polymers are possible by varying the viscosity through combination of various volatile and nonvolatile silicone, perfluorocarbon, perfluorosilicone, fluorinated alcohol, or perfluorinated polyether polymers. For example, unmodified silicones are insoluble in water and other polar compounds. However, they will emulsify well using more common emulsifying agents. It is contemplated that all silicone emulsions may be used.

Silicones can also be modified or changed to improve solubility. According to one embodiment, silicones are fluorinated to form, for example, perfluorosilicones. The silicones may be fluorinated in a range of about 0.5% to 20%. Fluorinating the silicones improves the oleophobicity of the molecules, resulting in a composition that reduces the concentration of lipid deposits on the conditioned contact lens. Additionally, the improved oleophobicity of the composition increases the duration of therapeutic effect and, accordingly, the duration of comfortable contact lens wear.

Exemplary perfluorosilicones include perfluorononyl dimethicone and dimethicone propylethylenediamine behenate. Preferred perfluorosilicones are hydrophobic, oxygen permeable, oleophobic, and have a range of possible viscosities for various topical applications.

Polymer compositions dissolve well in and will dissolve non-polar materials. Non-polar materials include essential oils, mineral oil, fixed oils, light esters, and sunscreen agents. In addition, polymer compositions greatly minimize, if not eliminate, irritation from sunscreen agents, making possible added ultraviolet light (uv) protection over the corneal surface. Solubility decreases, however, as the size and viscosity of the polymer composition increases.

A second class of compounds is perfluorocarbon polymers, which offer similar properties of hydrophobicity, oxygen permeability, and variation in viscosity as the silicone polymers. In addition, some perfluorocarbons are more hydrophobic and can be used to retard protein and mucin deposits and to absorb the lipid deposits, like the silicone polymers.

Perfluorocarbons offer many of the same characteristics as the silicones—hydrophobic, highly oxygen permeable, with a greater range of lipophilicity, and may be used as dry eye and contact lens conditioning agents. According to one embodiment, lipophilic perfluorocarbons are preferred. Viscosity can be increased for preinsertion contact lens conditioning gels and less viscous compositions used for topical application to the eye or lens during wear.

Examples of perfluorocarbons used in preferred embodiments to provide dry eye and/or contact lens conditioning include perfluoromethylcyclohexylpiperidine (PFMCP), perfluorooctyl ethane (PFOE), perflubron (PFOB), perfluorohexyl bromide (PFHB), perfluorooctyl iodide (PFOI), and dibromoperfluorohexane (diBrPFH). According to a preferred embodiment, perfluoro-n-octane is used.

According to one embodiment, derivatives of perfluorocarbons, such as perfluoroalkanes, that are oxygen permeable and hydrophobic are also used to form the composition. Exemplary perfluoroalkanes include perfluorohexylhexane (F6H6) and perfluorohexyloctane (F6H8). Perfluoroalkanes may also be combined with silicone oils, for example, in a ratio of 70% perfluoroalkane to 30% silicone. One exemplary combination is perfluorononyl dimethicone.

The exemplary perfluorocarbons offer a range of lipid solubilities from nearly insoluble to fairly highly lipid soluble. Perfluoroalkanes may also be combined with emollients, such as docosyl docosanoate, to increase the viscosity of the composition and increase the adherence of the composition to the eye or contact lens.

Perfluorocarbons are biochemically inert and have been used as blood substitutes. The perfluorocarbons have additional properties which allow their use as an emulsion or allow lipophilic drugs to be carried in the more lipid soluble perfluorocarbons. These agents condition contact lenses and seal the surfaces from water loss to optimize shape retention and reduce deposits.

A third class of compounds is fluorinated alcohols. Fluorinated alcohols offer similar properties of hydrophobicity, oxygen permeability, and variation in viscosity as the silicone and perfluorocarbon polymers. In addition, some fluorinated alcohols are hydrophobic and can be used to retard protein and mucin deposits and to absorb the lipid deposits, like the silicone and perfluorocarbon polymers.

Exemplary fluorinated alcohols include the perfluoroalkylethanols and omega-perfluoroisopropoxy-perfluoroalkyl ethanols having two to twelve carbon atoms in the perfluoroalkyl groups, as well as the propanol homologues thereof. Most preferred are the perfluoroalkyl ethanols having six to twelve carbon atoms in the perfluoroalkyl groups, and mixture thereof. According to a preferred embodiment, the composition comprises dioctyldodecylfluoroheptyl citrate.

A fourth class of compounds are perfluorinated polyethers, including Fomblin Z and Fomblin Z-dol lubricants. Fomblins are modified perfluorinated polyethers having the general formula X—(OCF₂)ₓ—(OCF₂ CF₂₎—O—X with x=CF₃ for Fomblin Z; and x=CF₂CH₂OH for Fomblin Z-dol. Polyethylene glycol zdols, polypropylene glycol zdols, or dihydroxy derivatives of perfluoropolyoxyalkane (Fomblin Z DOL, Solvey Solexis, Inc. Thorofare, N.J.) are preferred embodiments. Perfluorinated polyethers offer similar properties of hydrophobicity, oxygen permeability, and variation in viscosity as the silicone, perfluorocarbon and fluorinated alcohol polymers.

Silicones, perfluorosilicones, perfluorocarbons, fluorinated alcohols and perfluorinated polyethers all have properties of hydrophobicity and oxygen permeability that may make them suitable as dry eye and/or contact lens conditioning agents. Fluorinated polymers, for example, perfluorocarbons, perfluorosilicones and perfluoroalkanes, are also oleophobic (they do not dissolve oil). This has advantages for prevention of oil deposits on contact lens surfaces. Perfluorocarbons and other fluorinated polymers also reduce adherence of oils, proteins and other lipids to the surface of the contact lens.

According to another embodiment, the composition comprises a combination of two or more of the following polymers: silicones, perfluorosilicones, perfluorocarbons, fluorinated alcohols and perfluorinated polyethers. Combining these polymers confers further advantages for a dry eye and/or contact lens conditioning agent, adding properties such as oleophobicity (oil insolubility) while retaining some silicone properties and promoting better adherence. Examples of such a compound include perfluorononyl dimethicone, with a range of viscosities. Other similar combinations of perfluorocarbon and silicone are possible. By substituting fluorine in various percentages (ranging from about 1% to at least 20%) into dimethicone, a range of spreadability and oleophobicity is achieved. Viscosities ranging from about 1 to 15,000 centistokes are possible. Lower viscosities allow for topical application during contact lens wear; higher viscosities serve as gels for preinsertion conditioning of contact lens surfaces.

According to one embodiment of the invention, the polymer composition further comprises a therapeutic agent. According to a preferred embodiment, the therapeutic agent is lipophilic. Exemplary therapeutic agents include an anti-rejection agent such as cyclosporine, an antibiotic, an antimicrobial, a vasoconstrictor, a pupil size management agent, a glaucoma agent, a macular degeneration agent, or an agent to arrest the development of cataracts. Furthermore, the therapeutic agent may be a slow-release formulation.

According to one embodiment, the therapeutic agent is cyclosporin, a known anti rejection drug with properties for relieving dry eye. Cyclosporin will not solubilize in an aqueous environment and cannot be carried in an aqueous vehicle. However, silicone polymers, and the more lipophilic perfluorocarbons, can solubilize cyclosporin. Application of an adherent thin film layer of the composition to the surface of the eye or contact lens allows for slow release of cyclosporin to the ocular tissue. Therapeutic release of cyclosporin to ocular tissue over time further minimizes the inflammatory reaction and treats dry eye more potently.

According to another embodiment of the invention, the therapeutic agent is an antibiotic. Antibiotics include, but are not limited to, antibacterial agents, antifungal agents, antimycobacterial agents, antiparasitic agents, antiviral agents, and vaccines. Examples of antibiotics include, but are not limited to, polymoxin B, bacitracin, sulfacetamide, erythromycin, fluoroquinolones, levofloxacin, neomycin, tobramycin, vancomycin, aminoglycosides, ciprofloxacin, norfloxacin, oflaxacin, amphoB, fluconazole, chlorhexidine, natamycin, acyclovir, and trifluridine.

According to another embodiment of the invention, the therapeutic agent is a vasoconstrictor. It is desireable when wearing contact lenses to minimize vasodilation and redness. However, alpha agonist vasoconstrictors, normally used topically to reduce redness, are not medically safe when soft contact lenses are worn. The free water within a soft contact lens acts as a reservoir and can significantly increase the concentration of alpha agonist delivered to the eye. Rebound redness is a known problem of topical alpha agonists when concentrations that are too high are delivered, or when repeat exposure more than once or twice a day results.

The conditioning agents of the present invention result in a waterproof seal of the lens surface(s). Topical vasoconstrictors, for example, oxymetazoline, can be used with soft contact lenses treated with the composition of the present invention without undue risk, since the vasoconstrictor will not be taken up in the now sealed contact lens. Additional exemplary vasoconstrictors include, but are not limited to, epinephrine, norepinephrine, levonordefrin, amphetamine, methamphetamine, hydroxyamphetamine, ephedrine, phenylephrine, isoproteronol, dopamine, methoxamine, tyramine, and metaraminol.

According to another embodiment of the invention, the therapeutic agent is a pupil size management agent. Pupil size management agents include, but are not limited to, imidazoline, phentolamine, phenoxybenzamine, and alpha-1 antagonist. As used in the present application, alpha 1 antagonist refers to any agent that binds to the alpha 1 adrenergic receptor, which includes alpha 1 adrenergic receptor antagonist. Preferably, the alpha 1 adrenergic receptor is iris smooth muscle dilator selective. More preferably, the alpha 1 antagonist is in the phentolamine family, known as imidazolines, an alkylating agent such as phenoxybenzamine, or a piperazinyl quinazoline with more potent alpha-1 adrenergic antagonist activity than dapiperazole. Most preferably, the alpha 1 antagonist of the invention is phentolamine or phenoxybenzamine, but any alpha 1 antagonist can be used in the present invention. Pupil size management agents are described in more detail in U.S. Pat. Nos. 6,291,498, 6,420,407, and 6,515,006 to common inventor, Gerald Horn, whose teachings are incorporated by reference in their entirety.

According to another embodiment of the invention, the therapeutic agent is an agent to treat glaucoma. Glaucoma therapeutic agents include, but are not limited to, beta-blockers, prostaglandin analogs, alpha-agonists, carbonic anhydrase inhibitors, and cholinergic agents.

According to another embodiment, the therapeutic agent is an agent to treat macular degeneration. Macular degeneration therapeutic agents include, but are not limited to, antioxidants such as vitamin C, vitamin E and beta-carotene, zinc, and copper, and pharmaceuticals such as verteporfin (Visudyne; Novartis Pharmaceuticals Corp.) and pegaptanib sodium (Macugen; Eyetech Pharmaceuticals, Inc. and Pfizer Ophthalmics).

According to another embodiment, the therapeutic agents is an agent to treat allergic conjunctivitis. Allergic conjunctivitis therapeutic agents include, but are not limited to, cromolyn, lodoxamide, olopatadine, antihistamines such as emedastine and levocabastine, corticosteroids, and inflammatory mediators such as azelastine, nedocromil and pemirolast.

Additional exemplary therapeutic agents, such as indomethacin and steroids such as androgens, prednisolone, prednisolone acetate, fluorometholone, and dexamethasones, may also be solubilized within the polymer composition with similar low irritation potential.

According to one embodiment of the invention, the polymer composition further contains solubilized fatty acids. The essential fatty acids include, for example, castor oil, corn oil, sunflower oil or light mineral oil, tocopheryl, and soluble forms of vitamin C. These additives offer improved tear film function.

According to one embodiment of the invention, the polymer composition further comprises a sunscreen. UVA and UVB sunscreen agents, for example but not limited to, oxybenzone, ethylhexyl methoxycinnamate, p-t-butyl p-methoxydibenzoylmethane, avobenzone, oxybenzone, octyl salicylate, octocrylene and octyl p-methoxycinnamate are solubilized in the polymer composition. Sunscreen dissolved in polymer composition is nonirritating and affords improved uv protection to the eye.

Using current ocular therapeutic agent delivery methods, when a drop of the polymer compound further comprising a therapeutic agent is applied, the blink mechanism and slow corneal absorption renders only a very small fraction of the therapeutic agent within that drop available for intraocular or surface retention. When such therapeutic agents are added to the polymer composition gels or topicals, the therapeutic agents slow release from the adherent films and increase the availability of such therapeutic agents.

While it is well known that aqueous compounds can be soaked into a contact lens for slow release, the present invention allows for embodiments with slow release of nonaqueous compounds on the adherent surface film while optimizing contact lens performance and minimizing the amount of a therapeutic agent necessary to treat a dry eye. Further, the volume of a therapeutic agent dissolved within the polymer composition is better controlled than with the high available water volume used by depot absorption of a therapeutic agent into a soft contact lens.

According to one embodiment of the invention, the polymer composition is adapted to treat a defect of an ocular epithelium, for example, the corneal epithelium or the stroma. Many types of eye surgery require delivery of therapeutic agents and protection of disrupted corneal epithelium and/or stroma. Surface ablation in laser eye surgery, including but not limited to photorefractive keratectomy (PRK), laser-assisted in situ keratomileusis (LASIK) and IntraLase LASIK, other types of eye surgery, including but not limited to cataract surgery using corneal incisions, corneal transplant surgery and glaucoma filtration surgery, epithelial abrasion, epithelial trauma, and any other cause of an epithelial defect requiring protection from further disruption. According to one embodiment, the polymer composition is applied to the surface of the eye, either with or without a protective contact lens, to seal the ocular or corneal epithelium from disruption. According to an alternative embodiment, the polymer composition further includes a therapeutic agent, for example, an antibiotic, to protect and to treat the defective or damaged ocular epithelium. Delivery of therapeutic agents within a silicone polymer, perfluorocarbon polymer, fluorinated alcohol, fluorinated silicon polymer, and/or perfluorinated polyether both protects the disrupted ocular tissue and provides therapeutic agents to treat the defective or damaged epithelium.

Laser eye surgery procedures are particularly well suited for treatment according to the invention. Current laser eye surgery art requires placement of a protective contact lens over the procedure created defect. Such lenses reduce oxygen permeability. A silicone polymer, perfluorocarbon polymer, fluorinated alcohol, fluorinated silicon polymer, and/or perfluorinated polyether retains oxygen permeability while acting as a protective bandage to cover the defect. Depending on the viscosity and oleophobicity of the selected polymer and/or combination of polymers, the polymer composition can obtain a long half-life, and maintain sealant protection of the treated epithelium. According to an alternative embodiment, the polymer composition further includes a therapeutic agent, such as an antibiotic, to treat the damaged epithelium during healing.

The hydrophobic nature of such conditioning agents minimizes protein and mucin deposition. Lipophilic preferred embodiments also solubilize many lipids that otherwise would deposit on the contact lens surface.

Clinical Study

A clinical evaluation was conducted to evaluate the therapeutic effects of applying a hydrophobic composition to the surface of a contact lens inserted into a subject's eye. A silicone polymer gel composition, consisting of a blend of dimethicone and cyclomethicone, was provided to twenty subjects. The composition is a blend of one low viscosity silicone polymer and one high viscosity silicone polymer, resulting in a blended composition for application to the contact lens surface with a viscosity of about 8,000 centistokes.

Twenty subjects administered the blended silicone polymer gel composition to both the anterior and posterior surfaces of one contact lens and inserted the conditioned contact lens into the subject's right eye. An unconditioned contact lens was inserted into the subject's left eye. Both the right and left eye of each subject were monitored at baseline, and at 2, 6, and 10 hours for one day for a thread test, tear break up time, comfort, glare, vision quality, dryness, lens fit, lens comfort, and ease of lens removal. All tests were performed using techniques known in the art. In this study, trends for improvement in the thread test and tear break up time were noted. Significant improvement in comfort and dryness were noted.

In a separate study, tear break up time testing demonstrated an increase in TBU of 20-35% following administration of the blended silicone polymer composition.

In a separate study, vision quality improved dramatically within 30-120 seconds of instillation of the blended silicone polymer; but improved even more dramatically after sequential instillation of isotonic aqueous saline. In less than 5 seconds, subject's experienced greater resolution, and greater ability to visualize point light sources with loss of previously seen glare and halo. The effect was prolonged, lasting an average of 4-8 hours following insertion of the conditioned contact lens.

In a separate study, contact lens removal was facilitated by the silicone polymer alone and or silicone polymer/aqueous solution combination. In cases where a daily wear contact lens inadvertently was slept in, removal of the lens remained a matter of a simple sliding of the lens and a pinching out of the eye; whereas in the same individual without the silicone polymer having been previously applied, removal was extremely difficult in all such situations due to tight adherence of the lens to the corneal epithelium.

Although there has been hereinabove described a particular composition for the purpose of illustrating the manner in which the invention may be used to advantage, it should be appreciated that the invention is not limited thereto. Accordingly, any and all modifications, variations or equivalent arrangements, which may occur to those skilled in the art, should be considered to be within the scope of the present invention as defined in the appended claims.

1. An eye preparation comprising a hydrophobic composition adapted to treat a subject's eye.

2. The eye preparation of claim 1 wherein the composition has a viscosity of 1 to 15,000 centistokes.

3. The eye preparation of claim 1 wherein the composition has a viscosity of 1 to 8,000 centistokes.

4. The eye preparation of claim 1 wherein the composition is applied directly to a subject's eye.

5. The eye preparation of claim 1 wherein the composition is in the form of a liquid, a gel, or an emulsion.

6. The eye preparation of claim 1 wherein the composition is adapted to treat a defect of an ocular epithelium.

7. The eye preparation of claim 1 wherein the composition further comprises a therapeutic agent.

8. The eye preparation of claim 7 wherein the therapeutic agent is lipophilic.

9. The eye preparation of claim 7 wherein the therapeutic agent is a sunscreen.

10. The eye preparation of claim 7 wherein the therapeutic agent is a slow release formulation.

11. The eye preparation of claim 1 wherein the composition is oxygen permeable.

12. The eye preparation of claim 1 wherein the composition comprises a silicone polymer.

13. The eye preparation of claim 12 wherein the silicone polymer comprises dimethicone.

14. The eye preparation of claim 12 wherein the silicone polymer comprises cyclomethicone.

15. The eye preparation of claim 12 wherein the silicone polymer comprises a blend of at least two of dimethicone, cyclomethicone, and silicone gum.

16. The eye preparation of claim 12 wherein the silicone polymer is fluorinated.

17. The eye preparation of claim 16 wherein increasing the fluorine concentration of the silicone polymer increases the oleophobicity of the composition.

18. The eye preparation of claim 16 wherein the fluorinated silicone polymer is perfluorosilicone.

19. The eye preparation of claim 18 wherein the perfluorosilicone is perfluorononyl dimethicone.

20. The eye preparation of claim 12 wherein the silicone polymer further comprises at least one of perfluorocarbon polymer and perfluoroalkane polymer.

21. The eye preparation of claim 1 wherein the composition comprises a perfluorocarbon polymer.

22. The eye preparation of claim 21 wherein the perfluorocarbon polymer is perfluoro-n-octane.

23. The eye preparation of claim 21 wherein the perfluorocarbon polymer is a perfluoroalkane polymer.

24. The eye preparation of claim 1 wherein the composition comprises a fluorinated alcohol.

25. The eye preparation of claim 24 wherein the fluorinated alcohol is dioctyldodecylfluoroheptyl citrate.

26. The eye preparation of claim 1 wherein the composition comprises a perfluorinated polyether.

27. The eye preparation of claim 26 wherein the perfluorinated polyether is Fomblin Z.

28. The eye preparation of claim 26 wherein the perfluorinated polyether is Fomblin Z-DOL.

29. The eye preparation of claim 1 wherein the composition comprises a blend of at least two of silicone polymer, fluorinated silicone polymer, perfluorocarbon polymer, fluorinated alcohol, and perfluorinated polyether.

30. The eye preparation of claim 1 wherein the composition is contained within a single or multi dose applicator.

31. The eye preparation of claim 1 wherein the composition reduces symptoms associated with dry eye.

32. The eye preparation of claim 1 wherein the composition protects the ocular epithelium from abrasion.

33. The eye preparation of claim 1 wherein the composition is clear in color.

34. A method for delivering a hydrophobic composition to a subject's eye, said method comprising the steps of:
providing a hydrophobic composition; and
introducing the hydrophobic composition to the eye;
wherein the composition is introduced in an amount sufficient to deposit a microfilm of the composition over at least a portion of the subject's eye.
